(19) United States
(12) Patent Application Publication
(10) Pub. No.: US 2021/0304201 A1
(43) Pub. Date: Sep. 30, 2021

(54) TRANSACTION VERIFICATION METHOD AND APPARATUS, STORAGE MEDIUM, AND ELECTRONIC DEVICE

(71) Applicant: BEIJING SANKUAI ONLINE TECHNOLOGY CO., LTD, Beijing (CN)

(72) Inventors: Chengyu LI, Beijing (CN); Tianyou ZHANG, Beijing (CN); Xuewu HAO, Beijing (CN)

(21) Appl. No.: 17/266,942

(22) PCT Filed: Jul. 15, 2019
(86) PCT No.: PCT/CN2019/096043

§ 371 Date: Feb. 8, 2021

(30) Foreign Application Priority Data
Aug. 7, 2018 (CN) 201810889456.6

(51) Int. Cl. G06Q 20/40; G06F 16/22

(52) U.S. Cl. CPC G06Q 20/401; G06Q 2220/00; G06F 16/2246

(57) ABSTRACT

A transaction verification method is provided, including: obtaining transaction information, and generating verification identification information according to the transaction information; storing the verification identification information as a leaf node in a verification block having a tree structure; obtaining root node information of the verification block and a verification path of the verification identification information in the verification block; and sending the verification identification information, the root node information, and the verification path to a first transaction party involved in the transaction information, so that the first transaction party verifies the transaction information.

### CROSS REFERENCE TO RELATED APPLICATIONS

This application is a national stage of an international application No. PCT/CN2019/096043, filed on Jul. 15, 2019 and entitled “TRANSACTION VERIFICATION METHOD AND APPARATUS, STORAGE MEDIUM, AND ELECTRONIC DEVICE.” The international application claims priority to Chinese Patent Application No. 201810889456.6, entitled “TRANSACTION VERIFICATION METHOD AND APPARATUS, STORAGE MEDIUM, AND ELECTRONIC DEVICE” and was filed on Aug. 7, 2018. Both applications are incorporated herein by reference in their entirety.

### TECHNICAL FIELD

The present disclosure relates to the field of computer technologies, and specifically, to a transaction verification method, a transaction verification apparatus, a storage medium, and an electronic device.

### BACKGROUND

After a consumer and a merchant complete a transaction order by using an offline payment system, sometimes the order needs to be verified. A verification method in the related art is to obtain a number in a one-to-one correspondence to the order, and use the number to perform a query in a transaction center database to complete the verification.

It should be noted that the information disclosed in the above background part is used only for enhancing the understanding of the background of the present disclosure, and therefore may include information that does not constitute the related art known to a person of ordinary skill in the art.

### SUMMARY

An objective of the present disclosure is to provide a transaction verification method, a transaction verification apparatus, a computer-readable storage medium, and an electronic device.

According to an aspect of the present disclosure, a transaction verification method is provided, including:

obtaining transaction information, and generating verification identification information according to the transaction information;

storing the verification identification information as a leaf node in a verification block having a tree structure;

obtaining root node information of the verification block and a verification path of the verification identification information in the verification block; and

sending the verification identification information, the root node information, and the verification path to a first transaction party involved in the transaction information, so that the first transaction party verifies the transaction information.

According to an aspect of the present disclosure, a computer-readable storage medium is provided, storing a computer program, the computer program, when executed by a processor, implementing the following steps:

obtaining transaction information, and generating verification identification information according to the transaction information;

storing the verification identification information as a leaf node in a verification block having a tree structure;

obtaining root node information of the verification block and a verification path of the verification identification information in the verification block; and

sending the verification identification information, the root node information, and the verification path to a first transaction party involved in the transaction information, so that the first transaction party verifies the transaction information.

According to an aspect of the present disclosure, an electronic device is provided, including a processor and a memory, where the memory is configured to store executable instructions of the processor, and the processor is configured to execute the executable instructions to perform the following steps:

obtaining transaction information, and generating verification identification information according to the transaction information;

storing the verification identification information as a leaf node in a verification block having a tree structure;

obtaining root node information of the verification block and a verification path of the verification identification information in the verification block; and

sending the verification identification information, the root node information, and the verification path to a first transaction party involved in the transaction information, so that the first transaction party verifies the transaction information.

It should be understood that the above general descriptions and the following detailed descriptions are merely for exemplary and explanatory purposes, and cannot limit the present disclosure.

### BRIEF DESCRIPTION OF THE DRAWINGS

The accompanying drawings herein, which are incorporated in the specification as a part of the specification, show embodiments in accordance with the present disclosure, and together with the specification are used to explain the principle of the present disclosure. Apparently, the accompanying drawings in the following description show merely some embodiments of the present disclosure, and a person of ordinary skill in the art may still derive other drawings from these accompanying drawings without creative efforts.

FIG. 1 is a schematic flowchart of steps of a transaction verification method according to an exemplary implementation of the present disclosure.

FIG. 2 is a schematic flowchart of some steps of a transaction verification method according to another exemplary implementation of the present disclosure.

FIG. 3 is a schematic flowchart of some steps of a transaction verification method according to another exemplary implementation of the present disclosure.

FIG. 4 is a schematic flowchart of some steps of a transaction verification method according to another exemplary implementation of the present disclosure.

FIG. 5 is a schematic flowchart of some steps of a transaction verification method according to another exemplary implementation of the present disclosure.

FIG. 6 is a schematic flow block diagram of a transaction verification method in an application scenario according to an exemplary implementation of the present disclosure.

FIG. 7 is a schematic diagram of a verification block creation manner in a transaction verification method in an application scenario according to an exemplary implementation of the present disclosure.

FIG. 8 is a schematic structural diagram of a Merkle tree in a transaction verification method in an application scenario according to an exemplary implementation of the present disclosure.

FIG. 9 is a schematic diagram of a transaction verification process in a transaction verification method in an application scenario according to an exemplary implementation of the present disclosure.

FIG. 10 is a schematic block diagram of components of a transaction verification apparatus according to an exemplary implementation of the present disclosure.

FIG. 11 is a schematic block diagram of components of a transaction verification apparatus according to an exemplary implementation of the present disclosure.

FIG. 12 is a schematic block diagram of components of a transaction verification apparatus according to an exemplary implementation of the present disclosure.

FIG. 13 is a schematic diagram of a program product according to an exemplary implementation of the present disclosure.

FIG. 14 is a schematic diagram of modules of an electronic device according to an exemplary implementation of the present disclosure.

### DETAILED DESCRIPTION

At present, the exemplary embodiments are described comprehensively with reference to the accompanying drawings. However, the exemplary embodiments can be implemented in a plurality of forms, and are not to be understood as being limited to the examples described herein. Conversely, the embodiments are provided to make the present disclosure more comprehensive and complete, and comprehensively convey the concept of the exemplary embodiments to a person skilled in the art. The described features, structures, or characteristics may be combined in one or more implementations in any suitable manner.

In addition, the accompanying drawings are merely exemplary illustrations of the present disclosure and are not necessarily drawn to scale. The same reference numbers in the accompanying drawings represent the same or similar parts, and therefore, repeated descriptions thereof are omitted. Some of the block diagrams shown in the accompanying drawings are functional entities and do not necessarily correspond to physically or logically independent entities. Such functional entities may be implemented in the form of software, or implemented in one or more hardware modules or integrated circuits, or implemented in different networks and/or processor apparatuses and/or micro-controller apparatuses.

The verification method in the related art excessively relies on the transaction center database, and once related data stored in the transaction center database is tampered with or encounters a failure, a problem will occur during a verification process. In addition, in the verification method in the related art, merely a number is used as a verification credential, and the number is very likely to be forged, which results in a problem in data security. Consequently, it is difficult to ensure the authenticity of verification.

An exemplary implementation of the present disclosure first provides a transaction verification method, which improves data security and authenticity of verification. The method can be used for verifying a transaction order completed by a consumer and a merchant. Optionally, the transaction order is an order generated through an online transaction. Optionally, the transaction order is an order generated through an offline transaction. In addition, the method can alternatively be used for verifying an online transaction or offline transaction jointly participated by a plurality of transaction parties. This is not specifically limited in the present disclosure.

Referring to FIG. 1, the transaction verification method provided in this exemplary implementation includes the following steps:

S110: Obtain transaction information, and generate verification identification information according to the transaction information.

In S110, transaction information involved in a transaction order is first obtained. The transaction information includes an order number, a transaction time, identity information of transaction parties, a digest of transaction content, and other basic information. In addition, for a transaction completed by using an electronic transaction system, the transaction information further includes information about data interfaces that need to be invoked during a transaction order generation process and invocation status information of the data interfaces. Optionally, the invocation status information includes information indicating that an invocation is successful or information indicating that an invocation is failed. Then verification identification information corresponding to the transaction information is generated according to the obtained transaction information. Optionally, the verification identification information is information obtained after data in the transaction information is processed by using a specified algorithm. For example, the verification identification information is information obtained after the transaction information is encrypted, thereby improving the data security. For different transaction information, verification identification information generated should be different. Optionally, a format of the verification identification information is normalized, to facilitate data processing. For example, the format of the verification identification information is set to a character string of a fixed length, or the verification identification information is set to be in any other format according to a requirement. This is not specifically limited in this exemplary implementation.

S120: Store the verification identification information as a leaf node in a verification block having a tree structure.

After the verification identification information is generated through S110, the verification identification information is stored by using a verification block in S120. Optionally, a block body of the verification block is a storage region having a tree structure, and all verification identification information is stored as leaf nodes in the storage region having a tree structure. After a specified operation is performed for two or more leaf nodes at the bottom of the tree structure, one child node can be obtained, and after an operation continues to be performed for two or more child nodes, one parent node can be obtained. Through level-by-level upward operations, finally a root node is obtained, to form a complete tree structure. The tree structure is a binary-tree structure or a multi-way tree structure, and operations performed for child nodes at each level are the same or different.

S130: Obtain root node information of the verification block and a verification path of the verification identification information in the verification block.

After the verification identification information is stored in S120, a location of the verification identification information in the verification block is obtained in S130. That is, root node information of the verification block at which the verification identification information is located and a verification path of the verification identification information in the verification block are obtained. One verification block stores verification identification information of a plurality of transactions, and an amount of verification identification information stored in each verification block is limited. When a specific condition is met, a new verification block may be formed. In S130, by obtaining the root node information of the verification block, the verification block storing the verification identification information in a plurality of verification blocks can be learned, and by obtaining the verification path of the verification identification information in the verification block, the location in which the verification identification information is stored in the verification block can be accurately located.

S140: Send the verification identification information, the root node information, and the verification path to a first transaction party involved in the transaction information, so that the first transaction party verifies the transaction information.

In S140, the verification identification information generated in S110 and the root node information and the verification path that are obtained in S130 are sent to a first transaction party involved in the transaction information together. Optionally, the first transaction party is any one or several transaction objects involved in the transaction information. For example, for a two-party transaction participated by a consumer and a merchant, the verification identification information, the root node information, the verification path, and other related data may be separately sent to either of the consumer or the merchant, that is, either of a purchasing party or a selling party in S140. Alternatively, the related data is sent to both the consumer and the merchant in S140. For a multi-party transaction jointly participated by a plurality of transaction parties, the first transaction party is any one or several transaction parties in the plurality of transaction parties. After receiving the related data, the first transaction party can verify the corresponding transaction information by using the verification identification information, the root node information, and the verification path. The verification method includes using the received root node information to find a leaf node at the bottom from a root node of the verification block along the verification path, to determine whether information stored in the leaf node is consistent with the received verification identification information. Alternatively, the verification method includes using the received verification identification information to verify upward level by level from a leaf node at the bottom along the verification path, and finally a root node of the verification block is found. Subsequently, the found root node of the verification block is compared with the received root node information, and when the found root node of the verification block is consistent with the received root node information, it is considered that the verification is successful. In addition, another method for verifying the transaction information by using the verification identification information, the root node information, and the verification path can further be used in S140. This is not specifically limited in this exemplary implementation.

In the transaction verification method provided in this exemplary implementation of the present disclosure, transaction information of a plurality of transactions is converted into corresponding verification identification information, and the verification identification information is stored in a verification block having a tree structure. A specific composition form of a tree structure in each verification block is directly correlated to verification identification information stored in leaf nodes, and therefore can be used as a verification credential of transaction information. In addition, a verification block having a tree structure can store information of a plurality of transactions with no relationships originally in an associated manner, to prevent the transaction information from being tampered with or forged, thereby improving the security of data storage, and improving the authenticity of a verification result.

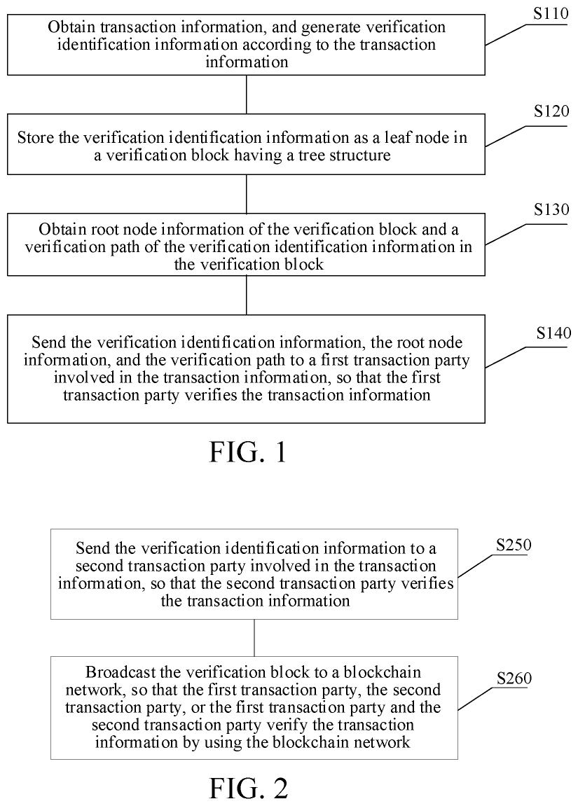

In another exemplary implementation of the present disclosure, another transaction verification method is provided. Referring to FIG. 2, based on the foregoing embodiment, the transaction verification method in this exemplary implementation further includes one or more of the following steps:

S250: Send the verification identification information to a second transaction party involved in the transaction information, so that the second transaction party verifies the transaction information.

In S250, the verification identification information corresponding to the transaction information is sent to a second transaction party involved in the transaction information, where the second transaction party is a transaction party different from the first transaction party. For example, if the first transaction party is a merchant, optionally, the second transaction party is a consumer. After receiving the verification identification information, the second transaction party verifies the transaction information according to a requirement. The verification method includes: the verification identification information is sent to the first transaction party, and then the first transaction party finds corresponding root node information and a corresponding verification path according to the verification identification information. After related data is found, the first transaction party may verify the transaction, and then returns a verification result to the second transaction party. In addition, the first transaction party can further directly return the found root node information and the found verification path to the second transaction party, and then the second transaction party verifies the transaction according to the verification identification information, the root node information, and the verification path.

S260: Broadcast the verification block to a blockchain network, so that the first transaction party, the second transaction party, or the first transaction party and the second transaction party verify the transaction information by using the blockchain network.

In addition to performing local verification by the first transaction party, the second transaction party, or the first transaction party and the second transaction party separately according to the verification identification information, the root node information, the verification path, and other related data, the verification block storing the verification identification information is broadcast to a blockchain network in S260. In this way, the first transaction party, the second transaction party, or the first transaction party and the second transaction party can verify the transaction information by using the blockchain network. As a block constituting the blockchain network, in addition to a block body having a tree structure, each verification block further includes a block header, where the block header is used for storing identification information of a current block. The identification information of the current block can be generated through operations according to one or more of a plurality of types of data such as identification information of a previous block, root node information of a tree structure in the current block, a timestamp, and a random number. In addition, the block header can alternatively separately store a plurality of types of data such as identification information of a previous block, root node information of a tree structure in the current block, a timestamp, and a random number. If the first transaction party, the second transaction party, or the first transaction party and the second transaction party needs to verify a transaction, whether the transaction really exists is determined by searching the blockchain network according to existing data, so as to complete verification on the transaction information. For example, the existing data is verification identification information, root node information, and a verification path.

This exemplary implementation provides a plurality of verification methods for a plurality of transaction objects. Especially, by means of broadcasting a verification block to a blockchain network, the security of data storage is improved, and the authenticity of information about each transaction is greatly ensured in the blockchain network.

In the foregoing exemplary implementation, the verification path obtained in S130 includes: information about child nodes in an ordered arrangement for verifying the verification identification information. For example, a shortest path connecting a root node and a corresponding leaf node on the tree structure is first obtained, then information about all child nodes involved in the path is sequentially obtained, and the child nodes are sequentially arranged from the root node to the leaf node or from the leaf node to the root node. Optionally, the verification path is other information about child nodes in an ordered arrangement for verifying the verification identification information. This is not specifically limited in the present disclosure.

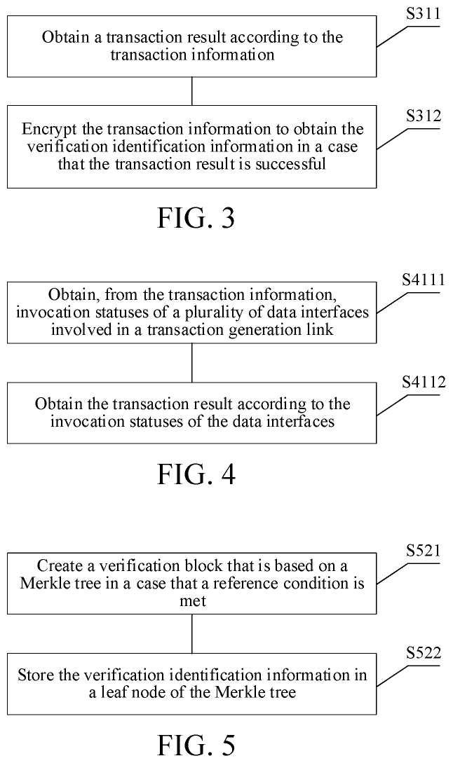

In another exemplary implementation of the present disclosure, another transaction verification method is provided. Referring to FIG. 3, based on any one of the foregoing embodiments, the generating verification identification information according to the transaction information in S110 may include the following steps:

S311: Obtain a transaction result according to the transaction information.

In S311, a transaction result is first obtained according to the transaction information, where the transaction result includes that a transaction is successful or a transaction is failed. In a case that transaction interruption or any other transaction abnormality caused by problems such as a network failure, network latency, and a system failure occur, the transaction may consequently be failed. If the transaction result is failed, no verification identification information needs to be generated.

S312: Encrypt the transaction information to obtain the verification identification information in a case that the transaction result is successful.

When the transaction result obtained in S311 is successful, the transaction information is encrypted in S312, and corresponding verification identification information is obtained after the encryption. Optionally, during encrypting the transaction information, a symmetric encryption algorithm such as a DES algorithm, a 3DES algorithm, a TDEA algorithm, a Blowfish algorithm, an RCS algorithm, or an IDEA algorithm is used; optionally, an asymmetric encryption algorithm such as an RSA algorithm, an Elgamal algorithm, a knapsack algorithm, or an elliptic curve cryptography is used. Optionally, any other encryption algorithm is used. This is not specifically limited in this exemplary implementation.

For example, the transaction information may be encrypted by using a hash encryption algorithm such as MD5, SHA-1, SHA-256, or SHA-512 in S312. A data format can be unified by using a hash encryption algorithm, which helps to establish and store a verification block having a tree structure.

In this exemplary implementation, the transaction information is encrypted when the transaction is successful, which improves data security, prevents data from being tampered with, and can also unify a data storage type and a data storage format, thereby improving data processing efficiency.

In another exemplary implementation of the present disclosure, another transaction verification method is provided. Referring to FIG. 4, based on the foregoing embodiment, S311, that is, the obtaining a transaction result according to the transaction information further includes the following steps:

S4111: Obtain, from the transaction information, invocation statuses of a plurality of data interfaces involved in a transaction generation link.

In S4111, invocation statuses of a plurality of data interfaces are obtained from the transaction information about the transaction, to obtain a transaction result. The invocation statuses of the data interfaces include that an invocation is successful or an invocation is failed. The data interfaces are interfaces that are involved in the transaction generation link and that need to be invoked. For example, a plurality of platform systems such as a fund platform, a marketing platform, a shopping cart, and a transaction platform may be involved in an online transaction. The fund platform can provide a plurality of fund data interfaces such as a coupon, a red envelope, and a balance that can be used for payment; the marketing platform can provide a plurality of data interfaces for product presentation, activity presentation, price presentation, and the like; the shopping cart can provide data interfaces for establishing a subscription relationship, updating a product status and the like; and the transaction platform can provide data interfaces for price querying, stock querying, fund querying, payment channel selection, fund transferring, and the like. Whether a transaction can be performed smoothly depends on whether the data interfaces can be successfully invoked.

S4112: Obtain the transaction result according to the invocation statuses of the data interfaces.

After the invocation statuses of the data interfaces are obtained through S4111, an overall invocation result is evaluated to obtain a transaction result in S4112. If invocations of all the data interfaces involved therein are successful, the transaction result is successful. If an invocation of any data interface is failed, the transaction result is failed.

In this exemplary implementation, the transaction result is evaluated by using a poof of invocation (POI consensus mechanism). If invocations of all the data interfaces are successful, it is considered that the interface invocations reach a consensus, and in this case, the transaction result is successful. If invocation of any data interface is failed, it is considered that the interface invocations does not reach a consensus, and in this case, the transaction result is failed. By evaluating the transaction result based on the POI consensus mechanism, an evaluation result obtained is secure and reliable.

In another exemplary implementation of the present disclosure, another transaction verification method is provided. Referring to FIG. 5, based on any one of the foregoing embodiments, S120, that is, the storing the verification identification information as a leaf node in a verification block having a tree structure includes the following steps:

S521: Create a verification block that is based on a Merkle tree in a case that a reference condition is met.

In S521, whether the reference condition is met currently is first determined, and when it is determined that the reference condition is met, a verification block that is based on a Merkle tree is created. Optionally, the reference condition is that an amount of to-be-stored verification identification information reaches a reference amount. For example, the reference condition is set to that an amount of the to-be-stored verification identification information reaches 64. Then, when an amount of verification identification information that needs to be stored reaches 64, a verification block used for storing the 64 pieces of verification identification information is created, and counting is restarted. When an amount of to-be-stored verification identification information reaches 64 again, a new verification block is then created, and so on. The verification block creation manner based on a reference amount is applicable in cases in which a transaction volume is relatively stable. For example, the reference condition is that an amount of to-be-stored verification identification information reaches a reference amount, optionally, the reference amount is adjusted according to an actual transaction situation. For example, the reference amount is set to a transaction volume per minute on average on a transaction system currently, and in this way, a creation speed for verification blocks is basically kept at one per minute. This method saves resources and can reduce data verification delays. Optionally, in S521, the reference condition is set to that a time period that has elapsed since creation of a previous verification block reaches a reference time length. For example, the reference time length is directly set to one minute, then regardless of how much verification identification information is stored in a current verification block, one new verification block is fixedly generated per minute, and subsequent verification identification information will also be stored in the new verification block. The verification block creation manner based on a reference time length is applicable in cases in which a transaction volume has a relatively large fluctuation, thereby avoiding a problem of an excessively long waiting time for verification identification information storage. In addition to the two types of conditions including the reference amount and the reference time length, optionally, a creation manner and a creation speed of verification blocks is controlled by using any other reference condition. This is not specifically limited in this exemplary implementation.

S522: Store the verification identification information in a leaf node of the Merkle tree.

After the verification block is created through S521, the to-be-stored verification identification information is stored in a leaf node of a Merkle tree in S522, where the Merkle tree (also referred to as a hash tree) is a hash binary tree used for storing hash values. Optionally, if the verification identification information is a hash value obtained by performing an operation for the transaction information by using a hash encryption algorithm, the verification identification information is directly stored in a leaf node of the Merkle tree. Optionally, if the verification identification information is in another data form, a hash operation is first performed on the verification identification information to obtain a hash value, and then the corresponding hash value is stored in a leaf node of the Merkle tree. After the leaf node is stored, hash values stored on each two adjacent leaf nodes may be connected in series and combined into one character string, then a hash operation is performed on the character string, and an obtained hash value is stored in a child node at a higher level. Similarly, two adjacent child nodes are then connected in series and combined for a hash operation, subsequently an obtained hash value is stored in a parent node at a higher level, and the process is repeated until a root node is obtained. The root node also stores a hash value.

The verification block based on the Merkle tree can quickly generalize and store a large amount of transaction information, and also can ensure integrity of large-scale data, thereby improving the security of data storage, and ensuring accuracy of verification on the transaction information.

It should be noted that although the various steps of the method in the present disclosure are described in a specific order in the foregoing exemplary implementations, this does not require or imply that the steps are bound to be performed in the specific order, or all the steps shown are bound to be performed to achieve the desired result. Optionally, additionally or alternatively, some steps are omitted, a plurality of steps may be combined into one step for execution, and/or one step may be decomposed into a plurality of steps for execution, and the like.

The transaction verification method in the foregoing exemplary implementations is described below with reference to an application scenario.

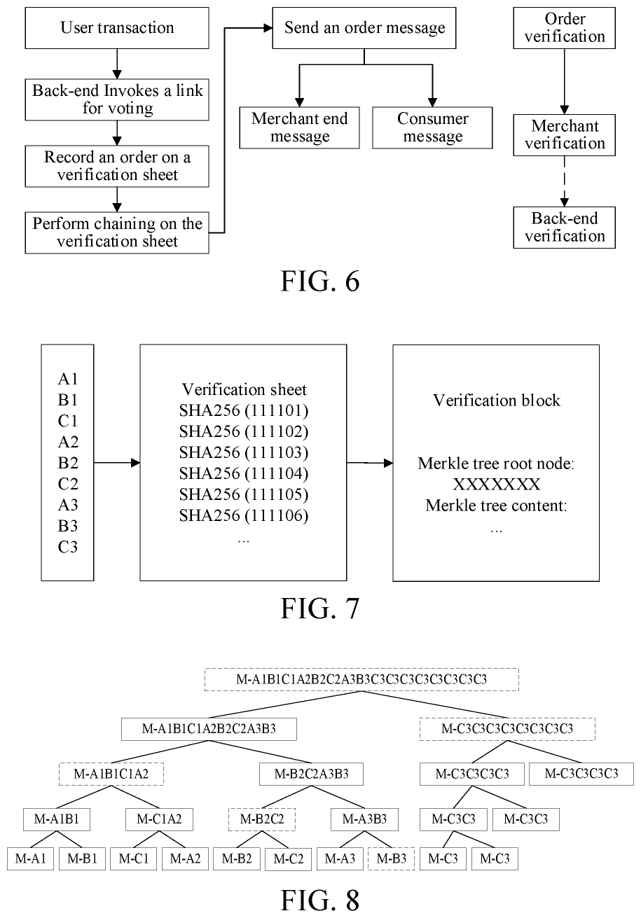

Referring to FIG. 6, this application scenario relates to a two-party transaction performed on a transaction system and jointly participated by a first transaction party and the second transaction party, where the first transaction party is a merchant, and the second transaction party is a consumer. When the consumer initiates a transaction to the merchant, the system back-end invokes data interfaces on a transaction generation link for voting, and each time a data interface on the link is successfully invoked, a vote is casted. In a case that a voting result indicates that all the data interfaces are successfully invoked, it is determined that the transaction is successful. Then an order of the transaction is stored on a verification sheet, where each verification sheet corresponds to one verification block. Subsequently, a chaining operation is performed for the verification sheet, that is, to broadcast the verification block to a blockchain network. Simultaneously, the transaction system separately sends a message to the merchant and the consumer. The merchant and the consumer verify transaction information according to a received message. Optionally, a verification process is: performing local verification by using a merchant end, or performing system back-end verification by using the blockchain network.

Performing an on-sheet operation for order information corresponding to a successful transaction is to record key information (an order number, hash encryption information, and the like) in an order on a verification sheet. For example, the order information is encrypted by using a SHA-256 encryption algorithm, and a unique SHA256 value is obtained for each transaction order. Referring to FIG. 7, A1, B1, C1, A2, B2, C2, A3, B3, and C3 respectively represent a transaction order, and order information about each order is stored on a verification sheet. Optionally, according to a transaction volume per minute of the transaction system, it is specified that an order volume of a verification sheet is N, and when an amount of orders in the verification sheet reaches N, the Merkle tree shown in FIG. 8 is created. M-A1 is a hash value obtained by performing a hash operation for order information about an order A1, M-B1 is a hash value obtained by performing a hash operation for order information about an order B1, and after M-A1 and M-B1 are connected in series and combined, a hash operation is performed again to obtain a hash value M-A1B1. For a last order C3, because no other order can be paired with C3, optionally, a hash value M-C3 and a hash value M-C3 are connected in series and combined, and then a hash operation is performed to obtain a hash value M-C3C3. The process is repeated, to fill the Merkle tree. The above two-two hash process is repeated, and finally a root node hash value is obtained.

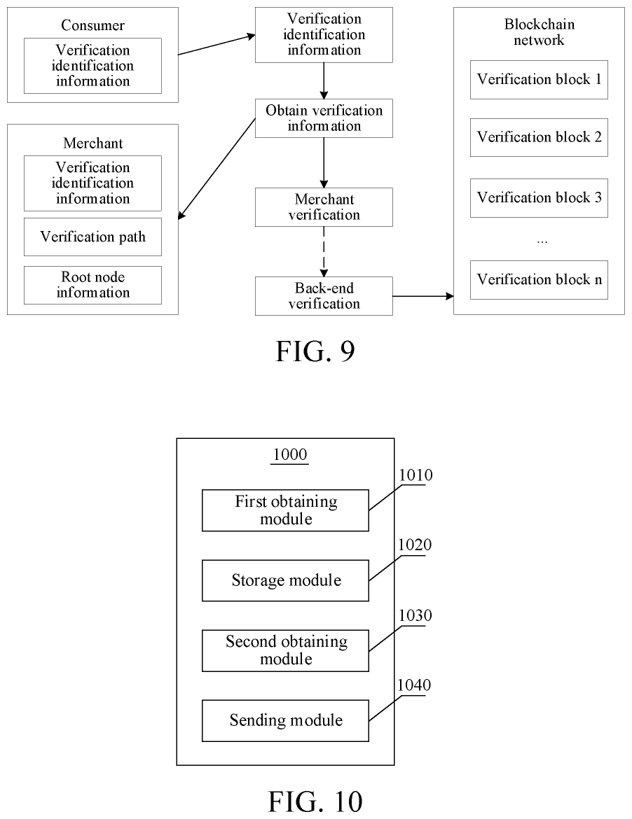

Referring to FIG. 9, each time a transaction is successfully performed to complete an order, three pieces of information related to the order are sent to the merchant: verification identification information (for example, a SHA256 value that is uniquely corresponding to the order and that is obtained after a hash operation), root node information, and a verification path. Simultaneously, the verification identification information is sent to the consumer. Still by using FIG. 8 as an example, a current order is A3, then the verification identification information sent to the consumer and the merchant is M-A3. Correspondingly, the root node information sent to the merchant is M-A1B1C1A2B2C2A3B3C3C3C3C3C3C3C3C3 on the top of a tree structure, and the verification path is child nodes in an ordered arrangement from the bottom to the top: M-B3, M-B2C2, M-A1B1C1A2, and M-C3C3C3C3C3C3C3C3, that is, the dashed line box part in the figure.

If an abnormality occurs in the transaction, for example, the consumer receives a message that the transaction is successful, but a merchant end displays that the transaction is failed, optionally, the consumer shows the verification identification information to the merchant actively or according to a merchant requirement. In this case, the merchant can find corresponding root node information and a corresponding verification path by using the verification identification information provided by the consumer. Then the merchant verifies transaction information by using the verification identification information, the corresponding root node information, and the corresponding verification path. One verification method is that: sequentially connecting the verification identification information and the child nodes M-B3, M-B2C2, M-A1B1C1A2, and M-C3C3C3C3C3C3C3C3 on the verification path in series and combined for a hash operation, and whether a finally obtained hash value is the same as the root node information is determined. If the finally obtained hash value is the same as the root node information, it is considered that the verification is successful, and the transaction is successful, authentic, and valid. In addition, in special situations such as a lag in receiving a message by the merchant end or a message loss, the merchant can alternatively perform back-end verification by using the blockchain network, that is, to determine whether a verification block on the blockchain network stores the transaction information. Provided that the transaction information is found on any verification block, it can also be determined that the verification is successful, and the transaction is successful, authentic, and valid.

In an exemplary implementation of the present disclosure, a transaction verification apparatus is further provided. Referring to FIG. 10, a transaction verification apparatus 1000 may mainly include: a first obtaining module 1010, a storage module 1020, a second obtaining module 1030, and a sending module 1040. The first obtaining module 1010 is configured to obtain transaction information, and generate verification identification information according to the transaction information. The storage module 1020 is configured to store the verification identification information as a leaf node in a verification block having a tree structure. The second obtaining module 1030 is configured to obtain root node information of the verification block and a verification path of the verification identification information in the verification block. The sending module 1040 is configured to send the verification identification information, the root node information, and the verification path to a first transaction party involved in the transaction information, so that the first transaction party verifies the transaction information.

In an exemplary implementation of the present disclosure, the sending module 1040 is further configured to send the verification identification information to a second transaction party involved in the transaction information, so that the second transaction party verifies the transaction information.

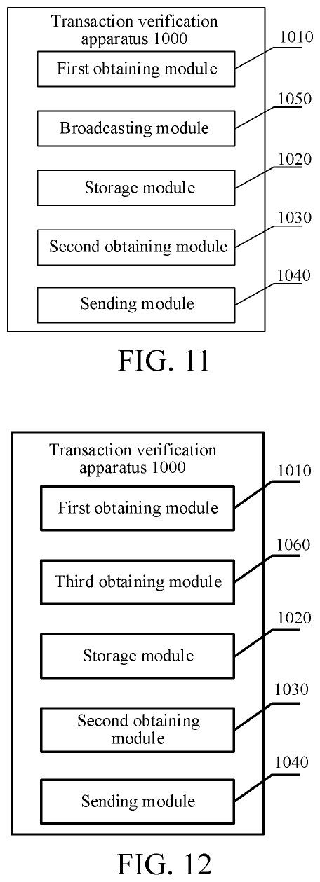

In an exemplary implementation of the present disclosure, referring to FIG. 11, the apparatus further includes:

a broadcasting module 1050, configured to broadcast the verification block to a blockchain network, so that the first transaction party, the second transaction party, or the first transaction party and the second transaction party verify the transaction information by using the blockchain network.

In an exemplary implementation of the present disclosure, the verification path includes: information about child nodes in an ordered arrangement for verifying the verification identification information.

In an exemplary implementation of the present disclosure, referring to FIG. 12, the apparatus further includes:

a third obtaining module 1060, configured to obtain a transaction result according to the transaction information; and

the first obtaining module 1010 being configured to encrypt the transaction information to obtain the verification identification information in a case that the transaction result is successful.

In an exemplary implementation of the present disclosure, the third obtaining module 1060 is configured to: obtain, from the transaction information, invocation statuses of a plurality of data interfaces involved in a transaction generation link; and obtain the transaction result according to the invocation statuses of the data interfaces.

In an exemplary implementation of the present disclosure, the third obtaining module 1060 is configured to: in a case that the invocation statuses of the data interfaces all indicate that an invocation is successful, determine that the transaction result is successful; and in a case that the invocation status of any data interface indicates that an invocation is failed, determine that the transaction result is failed.

In an exemplary implementation of the present disclosure, the first obtaining module 1010 is configured to encrypt the transaction information by using a hash algorithm to obtain the verification identification information.

In an exemplary implementation of the present disclosure, the storage module 1020 is configured to: create a verification block that is based on a Merkle tree in a case that a reference condition is met; and store the verification identification information in a leaf node of the Merkle tree.

In an exemplary implementation of the present disclosure, the reference condition includes: an amount of to-be-stored verification identification information reaches a reference amount.

In an exemplary implementation of the present disclosure, the reference condition includes: a time period that has elapsed since creation of a previous verification block reaches a reference time length.

Details of the transaction verification apparatus have been specifically described in the corresponding transaction verification method. Therefore, details are not described herein again.

It should be noted that although a plurality of modules or units of a device configured to perform actions are discussed in the foregoing detailed description, such division is not mandatory. In practice, according to the implementations of the present disclosure, the features and functions of two or more modules or units described above may be implemented in one module or unit. On the contrary, the features and functions of one module or unit described above may be further divided to be implemented by a plurality of modules or units.

In an exemplary implementation of the present disclosure, a computer-readable storage medium is further provided, storing a computer program, the computer program, when executed by a processor, implementing the foregoing transaction verification method in the present disclosure. In some possible implementations, each aspect of the present disclosure is further implemented in a form of a program product including program code. The program product is stored in a non-volatile storage medium (which is a compact disk read-only memory (CD-ROM), a USB flash drive, a removable hard disk, or the like) or on a network. When the program product is run on a computing device (which may be a personal computer, a server, a terminal apparatus, a network device, or the like), the program code is used to enable the computing device to perform steps of the method in the foregoing exemplary embodiments of the present disclosure.

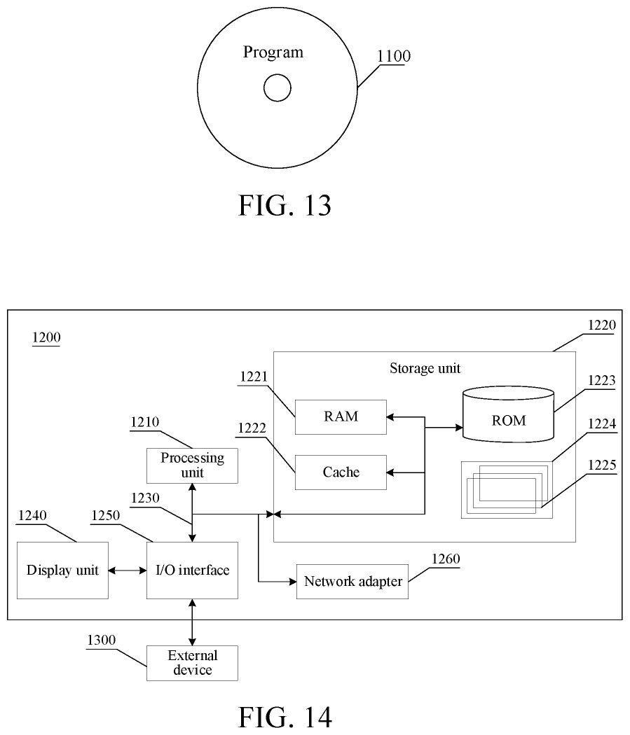

Referring to FIG. 13, a program product 1100 configured to implement the foregoing methods according to the implementations of the present disclosure is described, and the program product may use a portable CD-ROM and includes program code, and may be run on a computing device (such as a personal computer, a server, a terminal apparatus, or a network device). However, the program product of the present disclosure is not limited to thereto. In this exemplary embodiment, the computer-readable storage medium may be any tangible medium including or storing a program, and the program may be used by or in combination with an instruction execution system, apparatus or component.

The program product may be any combination of one or more readable mediums. The readable medium may be a readable signal medium or a readable storage medium.

The readable storage medium may be, for example, but is not limited to, an electric, magnetic, optical, electromagnetic, infrared, or semi-conductive system, apparatus, or device, or any combination thereof. More specific examples of the readable storage medium (a non-exhaustive list) include: an electrical connection having one or more wires, a portable disk, a hard disk, a random access memory (RAM), a read-only memory (ROM), an erasable programmable ROM (EPROM or a flash memory), an optical fiber, a portable CD-ROM, an optical storage device, a magnetic storage device, or any appropriate combination thereof.

The readable signal medium may include a data signal propagated in a baseband or as part of a carrier, and stores readable program code. A data signal propagated in such a way may assume a plurality of forms, including, but not limited to, an electromagnetic signal, an optical signal, or any appropriate combination thereof. The readable signal medium may alternatively be any readable medium other than the readable storage medium. The readable medium may be configured to send, propagate, or transmit a program used by or used in combination with an instruction execution system, an apparatus, or a device.

The program code included in the readable medium may be transmitted by using any appropriate medium, including but not limited to, a wireless medium, a wired medium, an optical cable, radio frequency (RF), or the like, or any appropriate combination thereof.

A program code for performing the operations of the present disclosure may be written by using any combination of one or more programming languages. The programming language includes an object-oriented programming language such as Java, or C++, and a conventional procedural programming language such as a “C” Language or a similar programming language. The program code may be completely executed on a user computing device, partially executed on user computing equipment, executed as an independent software package, partially executed on a user computing device and partially executed on a remote computing device, or completely executed on a remote computing device or server. In cases involving a remote computing device, the remote computing device may be connected to a user computing device through any type of network (including a local area network (LAN) or a wide area network (WAN)), or may be connected to an external computing device, for example, through the Internet by using an Internet service provider.

In an exemplary implementation of the present disclosure, an electronic device is further provided. The electronic device includes at least one processor and at least one memory configured to store executable instructions of the processor, the processor being configured to execute the executable instructions to perform the steps of the methods according to the foregoing exemplary embodiments in the present disclosure.

The electronic device 1200 in this exemplary implementation is described below with reference to FIG. 14. The electronic device 1200 is only an example, and does not impose any restriction on functions and scopes of use of the embodiments of the present disclosure.

Referring to FIG. 14, the electronic device 1200 is represented in a form of a general-purpose computing device. Components of the electronic device 1200 may include, but are not limited to: at least one processing unit 1210, at least one storage unit 1220, a bus 1230 connected to different system components (including the processing unit 1210 and the storage unit 1220), and a display unit 1240.

The storage unit 1220 stores program code, and the program code may be executed by the processing unit 1210, so that the processing unit 1210 performs the steps of the methods according to the foregoing exemplary embodiments in the present disclosure.

The storage unit 1220 may include a readable medium in the form of a volatile storage unit, for example, a RAM 1221 and/or a cache storage unit 1222, and may further include a ROM 1223.

The storage unit 1220 may further include a program/utility 1224 having a set of (at least one) program modules 1225. Such a program module includes, but is not limited to: an operating system, one or more application programs, other program modules, and program data. Each or a combination of these examples may include implementation of a network environment.

The bus 1230 may represent one or more of several types of bus structures, including a storage unit bus or storage unit controller, a peripheral bus, an accelerated graphics port, a processing unit, or a local bus using any one of a plurality of bus structures.

The electronic device 1200 may alternatively communicate with one or more external devices 1300 (such as a keyboard, a pointing device, and a Bluetooth device), may alternatively communicate with a plurality of devices that enable a user to interact with the electronic device 1200, and/or communicate with any device (such as router or a modem) that enables the electronic device 1200 to communicate with one or more other computing devices. Such communication may be performed by using an input/output (I/O) interface 1250. In addition, the electronic device 1200 may further communicate with one or more networks (such as a LAN, a WAN, and/or a public network (such as the Internet)) through a network adapter 1260. As shown in FIG. 12, the network adapter 1260 may communicate with other modules of the electronic device 1200 through the bus 1230. It is to be understood that although not shown in the figure, other hardware and/or software modules may be used in combination with the electronic device 1200, including, but not limited to microcode, a device driver, a redundancy processing unit, an external disk drive array, a RAID system, a tape drive, a data backup and storage system, or the like.

A person skilled in the art can understand that the aspects of the present disclosure may be implemented as systems, methods, or program products. Therefore, each aspect of the present invention can be specifically implemented in the following manners, that is, a hardware-only implementation, a software-only implementation (including firmware, microcode, and the like), or an implementation combining hardware and software, which can be collectively referred to as a “circuit”, “module” or “system” herein.

After considering the specification and practicing the present disclosure, a person skilled in the art can easily conceive of other implementations of the present disclosure. This application is intended to cover any variation, use, or adaptive change of the present disclosure. These variations, uses, or adaptive changes follow the general principles of the present disclosure and include common general knowledge or common technical means, which are not disclosed in the present disclosure, in the technology. The specification and the embodiments are considered to be merely exemplary, and the actual scope and spirit of the present disclosure are subject to the appended claims.

The described features, structures, or characteristics may be combined in one or more implementations in any suitable manner. If possible, the features discussed in the embodiments are interchangeable. In the foregoing descriptions, a lot of specific details are provided to give a comprehensive understanding of the implementations of the present disclosure. However, a person skilled in the art is to be aware that the technical solutions in the present disclosure may be implemented without one or more of the particular details, or other methods, elements, or materials may be used. In other cases, well-known structures, materials, or operations are not shown or described in detail, so as not to obscure the aspects of the present disclosure.

1. A transaction verification method, comprising:
obtaining transaction information, and generating verification identification information according to the transaction information;
storing the verification identification information as a leaf node in a verification block having a tree structure;
obtaining root node information of the verification block and a verification path of the verification identification information in the verification block; and
sending the verification identification information, the root node information, and the verification path to a first transaction party involved in the transaction information, so that the first transaction party verifies the transaction information.

2. The transaction verification method according to claim 1, further comprising:
sending the verification identification information to a second transaction party involved in the transaction information, so that the second transaction party verifies the transaction information.

3. The transaction verification method according to claim 1, further comprising:
broadcasting the verification block to a blockchain network, so that the first transaction party, a second transaction party, or the first transaction party and the second transaction party verify the transaction information by using the blockchain network, wherein the second transaction party is a transaction party involved in the transaction information and different from the first transaction party.

4. The transaction verification method according to claim 1, wherein the verification path comprises: information about child nodes in an ordered arrangement for verifying the verification identification information.

5. The transaction verification method according to claim 1, wherein the generating verification identification information according to the transaction information comprises:
obtaining a transaction result according to the transaction information; and
encrypting the transaction information to obtain the verification identification information in a case that the transaction result is successful.

6. The transaction verification method according to claim 5, wherein the obtaining a transaction result according to the transaction information comprises:
obtaining, from the transaction information, invocation statuses of a plurality of data interfaces involved in a transaction generation link; and
obtaining the transaction result according to the invocation statuses of the data interfaces.

7. The transaction verification method according to claim 6, wherein the obtaining the transaction result according to the invocation statuses of the data interface comprises:
in a case that the invocation statuses of the data interfaces all indicate that an invocation is successful, determining that the transaction result is successful; and
in a case that the invocation status of any data interface indicates that an invocation is failed, determining that the transaction result is failed.

8. The transaction verification method according to claim 5, wherein the encrypting the transaction information to obtain the verification identification information comprises:
encrypting the transaction information by using a hash algorithm to obtain the verification identification information.

9. The transaction verification method according to claim 1, wherein the storing the verification identification information as a leaf node in a verification block having a tree structure comprises:
creating a verification block that is based on a Merkle tree in a case that a reference condition is met; and
and storing the verification identification information in a leaf node of the Merkle tree.

10. The transaction verification method according to claim 9, wherein the reference condition comprises: an amount of to-be-stored verification identification information reaches a reference amount.

11. The transaction verification method according to claim 9, wherein the reference condition comprises: a time period that has elapsed since creation of a previous verification block reaches a reference time length.

12-22. (canceled)

23. A non-volatile computer-readable storage medium, storing a computer program, the computer program, when executed by a processor, implementing the following steps:
obtaining transaction information, and generating verification identification information according to the transaction information;
storing the verification identification information as a leaf node in a verification block having a tree structure;
obtaining root node information of the verification block and a verification path of the verification identification information in the verification block; and
sending the verification identification information, the root node information, and the verification path to a first transaction party involved in the transaction information, so that the first transaction party verifies the transaction information.

24. An electronic device, comprising:
a processor; and
a memory, configured to store executable instructions of the processor,
the processor being configured to execute the executable instructions to perform the following steps:
obtaining transaction information, and generating verification identification information according to the transaction information;
storing the verification identification information as a leaf node in a verification block having a tree structure;
obtaining root node information of the verification block and a verification path of the verification identification information in the verification block; and
sending the verification identification information, the root node information, and the verification path to a first transaction party involved in the transaction information, so that the first transaction party verifies the transaction information.

25. The electronic device according to claim 24, wherein the processor is further configured to execute the executable instructions to perform the following step:
sending the verification identification information to a second transaction party involved in the transaction information, so that the second transaction party verifies the transaction information.

26. The electronic device according to claim 24, wherein the processor is further configured to execute the executable instructions to perform the following step:
broadcasting the verification block to a blockchain network, so that the first transaction party, a second transaction party, or the first transaction party and the second transaction party verify the transaction information by using the blockchain network, wherein the second transaction party is a transaction party involved in the transaction information and different from the first transaction party.

27. The electronic device according to claim 24, wherein the processor is configured to execute the executable instructions to perform the following steps:
obtaining a transaction result according to the transaction information; and
encrypting the transaction information to obtain the verification identification information in a case that the transaction result is successful.

28. The electronic device according to claim 27, wherein the processor is configured to execute the executable instructions to perform the following steps:
obtaining, from the transaction information, invocation statuses of a plurality of data interfaces involved in a transaction generation link; and
obtaining the transaction result according to the invocation statuses of the data interfaces.

29. The electronic device according to claim 28, wherein the processor is configured to execute the executable instructions to perform the following steps:
in a case that the invocation statuses of the data interfaces all indicate that an invocation is successful, determining that the transaction result is successful; and
in a case that the invocation status of any data interface indicates that an invocation is failed, determining that the transaction result is failed.

30. The electronic device according to claim 27, wherein the processor is configured to execute the executable instructions to perform the following step:
encrypting the transaction information by using a hash algorithm to obtain the verification identification information.

31. The electronic device according to claim 24, wherein the processor is configured to execute the executable instructions to perform the following steps:
creating a verification block that is based on a Merkle tree in a case that a reference condition is met; and
and storing the verification identification information in a leaf node of the Merkle tree.
